(19) United States
(12) Patent Application Publication
(10) Pub. No.: US 2005/0000257 A1
(43) Pub. Date: Jan. 6, 2005

(54) Method and apparatus for securing an object to a vehicle

(76) Inventor: Donald Alan Bistline, Vista, CA (US)

Correspondence Address: Thomas M. Thibault, 11340 Vista Sorrento Pkwy #306, San Diego, CA, 92130, US

(21) Appl. No.: 10/613,896

(22) Filed: Jul. 3, 2003

(51) Int. Cl. E05B 73/00

(52) U.S. Cl. 70/58; 70/18

(57) ABSTRACT

A method and apparatus for securing an object to a vehicle comprises a mounting bracket for being fixedly secured to a vehicle. A mating unit is removably secured to the mounting unit, the mating unit comprising an adjustable shackle and a locking mechanism, the adjustable shackle operative to secure an object, such as a surfboard, snowboard, wakeboard, or skis, to the mating unit and mounting bracket.

### BACKGROUND

I. Field of Use

The present invention relates to the field of theft prevention devices. More specifically, the present invention relates to a method and apparatus for securing an object, such as a surfboard, to a structure such as a motor vehicle.

II. Description of the Related Art

The sport of surfing has gained in popularity in the United States and abroad over the past several years. It is estimated that there are currently 3.5 million people who enjoy surfing in the United States alone. In most cases, surfboards are transported to the ocean on top of a car via roof racks or in the bed of a pickup truck. The typical method of securing surfboards to car top roof racks is by a canvas or rubber straps.

One of the disadvantages of transporting surfboards via motor vehicle is that few vehicles are large enough to transport surfboards inside. Consequently, most people transport surfboards external to their vehicles. There exists removable or permanent roof-top racks for automobiles whereby one or more surfboards can be secured for transport. Individuals owning pickup trucks can simply place their surfboard(s) in the bed of the pickup truck.

One disadvantage of transporting large objects such as surfboards external to a vehicle is that they are highly visible and therefore attract thieves when an owner leaves the surfboard unattended. These large objects are difficult to secure against theft due to their large size and unibody construction. Most roof racks today do not have a way to lock the surfboard securely to the vehicle. In most cases, elastic straps are all that is used to secure the surfboard to the vehicle. These are quickly and easily removed by thieves.

Most available surfboard locking mechanisms use a steel cable that is attached to a “leash plug” in the surfboard. The other end of the cable is then secured to a structure on the vehicle using a padlock or the like. These systems are generally easy for thieves to defeat, because the steel cable can be cut quickly with bolt cutters, or the leash plug can be destroyed.

A locking mechanism that does not rely on steel cables is described in a patent issued to Bolich (U.S. Pat. No. 5,582,044). In this patent, a surfboard is secured to the top of two roof racks using four independent locking mechanisms located at four edges of the surfboard. However, this device requires four elaborate locking mechanisms, which may be expensive to build and to purchase. Another drawback of this mechanism is that the surfboard may be easily removed if only one of the four locking mechanisms is defeated. Yet another drawback is that it is time consuming to lock and unlock the surfboard using four separate locking mechanisms.

Another locking mechanism that does not rely on steel cables is described a PCT publication entitled “Surfboard Security Locking System” to Spry (WO01/60660). In this publication, a locking device is described that secures a surfboard to a car roof rack using an adjustable, U-shaped locking mechanism. Half of the locking mechanism is fixedly secured to a vehicle roof rack, while the other half is removable. A major drawback of this invention is that half of the U-shaped locking mechanism remains secured to the vehicle, even when a surfboard is not being transported. This results in added wind resistance to the vehicle, and also degrades the look and styling of the vehicle.

What is needed is a surfboard locking mechanism that is easy to remove and install, while providing a high degree of security.

### SUMMARY

A method and apparatus for securing an object to a vehicle. In one embodiment, an apparatus for securing an object to a vehicle comprises a mounting bracket for fixedly mounting to the vehicle and a mating unit removably connected to the mounting bracket. The mating unit comprises an adjustable shackle and a mating portion, the mating portion being fixedly secured to said adjustable shackle. The mating unit further comprises a locking mechanism, the locking mechanism operative to allow adjustment of the adjustable shackle in an unlocked position and to prevent adjustment of said adjustable shackle in a locked position. Finally, the security apparatus comprises means for removably securing the mating portion to the mounting bracket.

In another embodiment, a method for securing an object to a vehicle comprises installing a mounting bracket fixedly to the vehicle and removably attaching a mating unit to the mounting bracket. The mating unit comprises an adjustable shackle operative to secure the object to the mating unit. The surfboard is placed through an opening formed by the adjustable shackle, and the shackle is adjusted to fit snugly against opposing sides of the object. The shackle is then locked, preventing theft of the object.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates one embodiment of a security apparatus for securing an object to a vehicle;

FIGS. 2a and 2b illustrate one embodiment of a mounting bracket of the security apparatus in FIG. 1;

FIG. 3 illustrates one embodiment of a mating unit, suitable for use with the security apparatus of FIG. 1;

FIG. 4 illustrates an optional cylinder for use with the mounting bracket of FIG. 2 shown in a close-up, cross-sectional view;

FIG. 5 illustrates the mating unit of FIG. 3 being removably installed onto the mounting bracket of FIG. 2, installed on an inside surface of a pickup truck tailgate;

FIG. 6 illustrates another embodiment of a security apparatus for securing an object to a vehicle;

FIG. 7 illustrates a mounting bracket suitable for use with the security apparatus of FIG. 6;

FIG. 8 illustrates a mating unit suitable for use with the security apparatus of FIG. 6;

FIG. 9 illustrates the mating unit of FIG. 8 about to be removably installed onto two mounting brackets shown in FIG. 7, installed on a vehicle roof rack;

FIG. 10 illustrates an optional fin guard for use with the security apparatus of FIG. 1 or FIG. 6;

FIG. 11 illustrates an optional fin guard in use with a surfboard and the security apparatus of FIG. 1 or FIG. 6;

FIGS. 12a and 12b illustrate two views of an optional cushion used in the security apparatus of FIG. 1 or FIG. 6;

FIGS. 13a and 13b are exploded views of yet another embodiment of a security apparatus for securing an object to a vehicle; and

FIG. 14 illustrates a flow diagram illustrating a method for securing an object to a vehicle.

### DETAILED DESCRIPTION

The methods and apparatus for securing an object to a vehicle detailed herein enable one to quickly and easily secure a surfboard to a vehicle to prevent theft. However, it should be understood that other types of articles could be secured in the alternative, such as snow skis, water skis, wakeboards, snowboards, etc. The described embodiments additionally allow the security apparatus to be quickly installed and removed, leaving only an unobtrusive mounting bracket remaining attached to the vehicle.

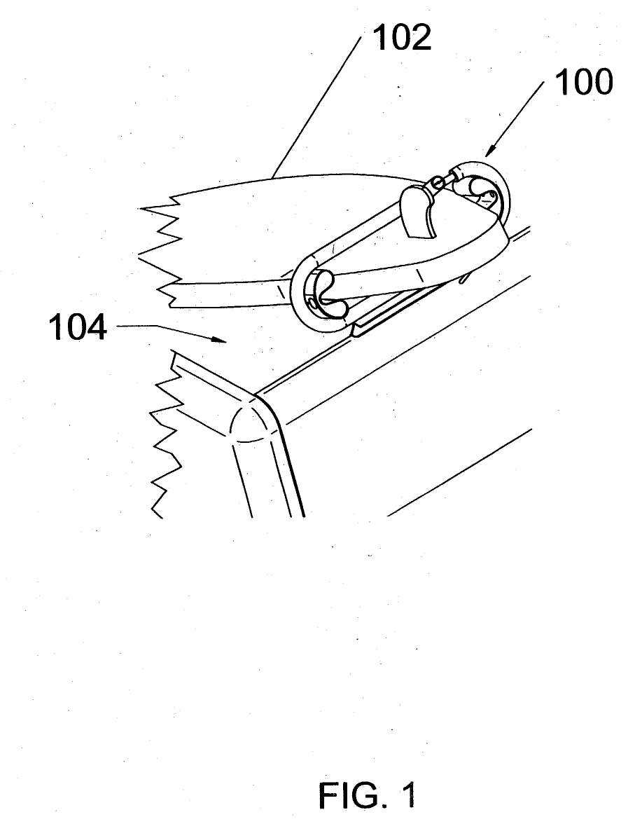

FIG. 1 illustrates one embodiment of a security apparatus 100 for securing an object to a vehicle. Shown is a surfboard 102 lying upside-down in the bed 104 of a typical pick-up truck. The rear portion of the surfboard extends past the tailgate of the pick-up truck with its tip lying on the floor of bed 104. The security apparatus 100 comprises a mounting bracket and mating unit, discussed later herein. The mating unit comprises an adjustable, locking shackle which is designed to fit snugly around the width of the surfboard 102 while in a locked position. The physical properties of the surfboard 102 (i.e., board contour, fin(s)) prevent it from being removed from the adjustable shackle. Other objects are retained within the adjustable shackle by their physical properties, such as board shape, bindings, etc. The mating unit is designed to be easily removed from the mounting bracket when security apparatus 100 is not in use, so that it does not interfere with other uses of the pick-up truck during normal use.

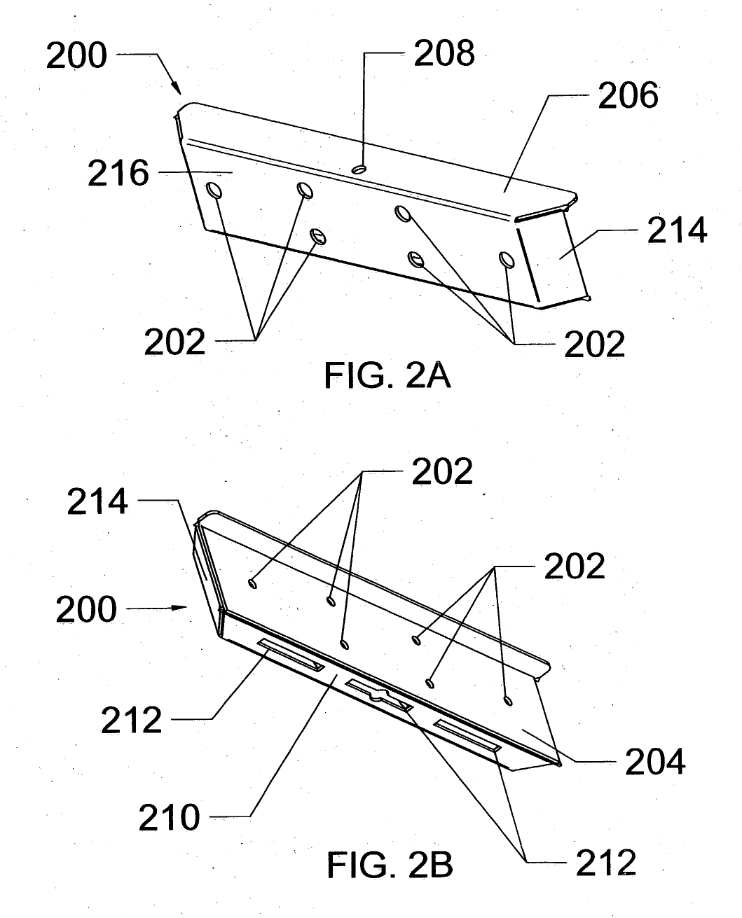

FIGS. 2a and 2b illustrate one embodiment of a mounting bracket 200, shown in two isometric views. The mounting bracket 200 is designed to be fixedly installed onto a vehicle, such as against an inside portion of a tailgate of a pickup truck. Of course, mounting bracket 200 could alternatively be located in other locations on a vehicle, such as the roof of any vehicle, or on any location in a bed 104 of a pickup truck, such as the outer portion of a tailgate, or on an inside or outside portion of bed 104. As used herein, the term “fixedly” generally means that mounting bracket 200 is not easily be removed.

Mounting bracket 200 is typically manufactured out of any durable, rigid material, such as any type of metal, wood, plastic, or other suitable material. It may comprise a hollow “box”, having a top surface 206, a bottom surface 210, side surfaces 214, and a rear planar surface 204. It may also include a front surface 216 for forming a hollow enclosure. A great number of alternative embodiments are possible, including mounting bracket 200 comprising only top surface 206, bottom surface 210, and rear planar surface 204. In another alterative embodiment, mounting bracket 200 comprises a solid block of material. In yet another alternative embodiment, mounting bracket 200 comprises only rear planar surface 204 and top surface 206. Mounting bracket 200 is also not restricted to a rectangular shape. As such, mounting bracket 200 may comprise a square, rectangle, triangle, circle, or other shape when viewed in a planar manner.

In the example of FIG. 1, mounting bracket 200 is fixedly attached to an inside portion of a pickup truck tailgate using one or more fastening devices, such as screws, bolts, rivets, or other known fastening devices, through mounting holes 202 located on a rear planar surface 204 and/or on front surface 216. Of course, mounting bracket 200 could be fixedly attached to a surface by using mounting brackets, or even by welding. The only limitation regarding the way in which mounting bracket 200 is fixedly attached to a surface is that it is not easily removable after installation.

In one embodiment, mounting bracket 200 comprises a top surface 206, having an aperture 208 located thereon, and a bottom surface 210, having, in this embodiment, three slots 212. Aperture 208 is designed to receive a rigid element, such as a pin, bolt, shackle, or other element which removably secures a mating unit, described later herein, to mounting bracket 200. The slots 212 are each designed to receive a tab from the mating unit. The combination of these two features allow the mating unit to be removably secured to mounting bracket 200. The term “revovably”, as used herein, generally means that the mating unit is able to be quickly and easily installed and removed from mounting bracket 200.

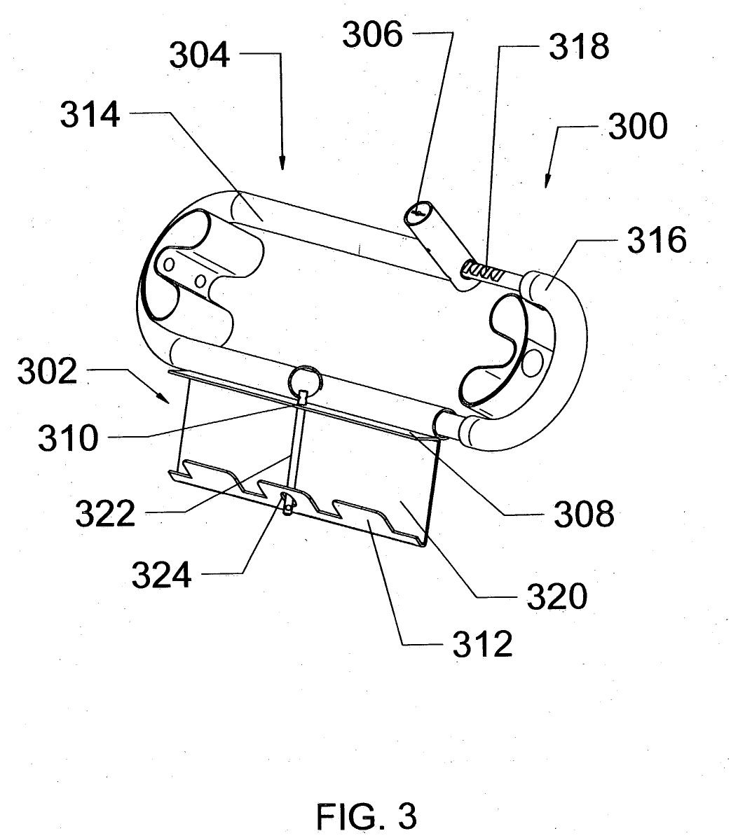

FIG. 3 illustrates one embodiment of a mating unit 300 and a retaining pin 322 of the security apparatus of FIG. 1. In this embodiment, mating unit 300 comprises a mating portion 302, an adjustable shackle 304, and a locking mechanism 306. Mating unit 300 is also preferably constructed of a rigid material such as metal, wood, plastic, rubber, or a combination of materials, strong enough to prevent a thief from destroying mating unit 300 during an attempted theft. A fixed portion 314 of adjustable shackle 304 is fixedly connected to a top surface 308 of mating portion 302, typically by welding or other suitable method known in the art. An adjustable portion 316 of adjustable shackle 304 inserts into fixed portion 314, thereby forming an adjustable opening through which surfboard 102, or other object, may be placed.

Both adjustable portion 316 and fixed portion 314 are preferably formed of a material not easily cut through with a hacksaw, for instance. The outer surface of each portion may additionally be covered with a hard plastic, rubber, or other material to add difficulty to anyone attempting to cut through either portion. Alternatively, or in addition to the hard material, padding may be deposited on fixed portion 314 and a portion of adjustable portion 316 so that minimal damage that might otherwise occur to an object that is secured by adjustable shackle 304.

Locking mechanism 306 comprises a combination or key-operated lock, similar to many adjustable locking devices in common use today. Examples of manufacturers offering such a locking mechanism include ABA locks (www.abalocks.com) and Royal Lock Corporation of Wauconda, Ill. Locking mechanism 306 typically comprises a spring-loaded deadbolt which engages a series of notches 318 located on adjustable portion 316: In an unlocked position, the deadbolt is pushed into a shank portion of locking mechanism 306 as each of notches 318 pass the deadbolt, thereby allowing free movement of adjustable portion 316 within fixed portion 314 and, thus, allowing an opening formed by adjustable shackle 304 to vary. In a locked position, the deadbolt is prevented from being pushed out of notches 318, thereby preventing the opening formed by adjustable shackle 304 from varying.

Mating portion 302 comprises a top surface 308, having an aperture 310 located thereon, a lower portion 312, and a plate 320 connecting top surface 308 and lower portion 312. Aperture 310 aligns with aperture 208 during assembly of mounting bracket 200 and mating unit 300, whereby retaining pin 322 is inserted through the apertures, removably securing mating unit 300 to mounting bracket 200. Retaining pin 322 comprises a pin, dowel, plug, shackle, wedge, or the like, that, when inserted through apertures 208 and 310 (and in combination with lower portion 312 and slots 212), prevents mating unit 300 from being removed from mounting bracket 200 and, hence, the vehicle. As just mentioned, in one embodiment, lower portion 312 comprises three “tabs” for insertion through slots 212 of mounting bracket 200. In other embodiments, there may be fewer or a greater number of tabs, the tabs could comprise pins, or any other extrusion, to fit within a corresponding slot, or other opening, on lower surface 210. In the embodiment of FIG. 3, the center tab comprises an aperture 324 which aligns with aperture 208 and receives retaining pin 322 during assembly of mounting bracket 200 and mating unit 300. In yet another embodiment, lower portion 312 could comprise a rectangular flange having no tabs, pins, or other extrusions, but comprises an aperture which aligns with an aperture located on lower surface 210 during assembly of mounting bracket 200 and mating unit 300. Retaining pin 322, having sufficient length, could then be inserted through both sets of apertures (i.e., aperture 208 and aperture 310, and the apertures located on lower portion 312 and lower surface 210), securing the two units together.

A key feature of the embodiments presented herein is that mating unit 300 is removably secured to mounting bracket 200 without the use of a locking mechanism. This allows quick installation and removal of the mating unit. In addition, a second key or combination is not needed (in addition to a key or combination for use with locking mechanism 306) to secure mating unit 300 to mounting bracket 200. The retaining pin 322 is prevented from being removed when a surfboard or similar object is secured through adjustable shackle 304 because the surfboard surface lays on top of retaining pin 322.

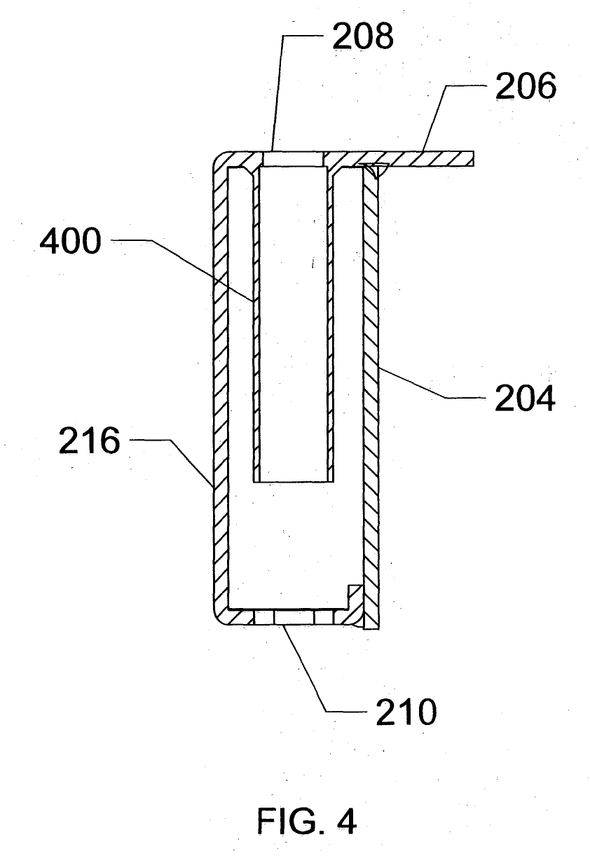

FIG. 4 illustrates an optional cylinder 400 for use with the mounting bracket of FIG. 2, shown in a close-up, cross-sectional view. The cylinder 400 prevents retaining pin 322 from being moved laterally from an alignment with aperture 208. This prevents a potential thief from attempting to remove retaining pin 322 by wiggling the pin and removing it in spite of surfboard 102 covering the pin. The cylinder 400 is typically welded to an undersurface of top surface 206 having a diameter sufficiently large enough to allow retaining pin 322 to be inserted therein.

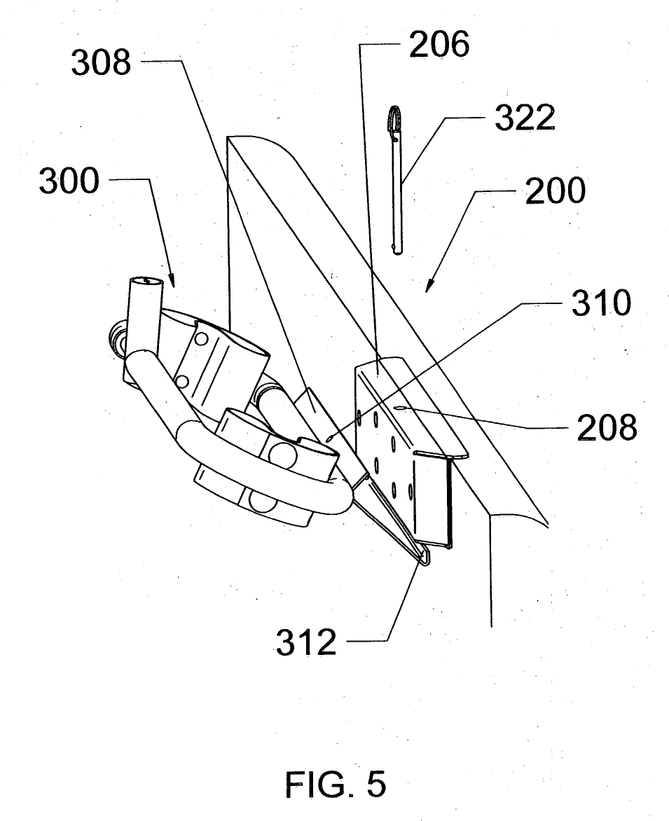

FIG. 5 illustrates the mating unit 300 of FIG. 3 being removably installed onto the mounting bracket 200 of FIG. 2, installed on an inside surface of a pickup truck tailgate, shown from a side view. Mounting bracket 200 is fixedly secured to the tailgate using the methods described above. Lower portion 312, comprising three tabs in this example, is inserted into slots 212, then mating unit 300 is pivoted so that top surface 308 of mating unit 300 covers top surface 206 of mounting bracket 200. Retaining pin 322 is then inserted through aperture 310 of mating unit 300, aperture 208 of mounting bracket 200, and optionally, an aperture located on lower portion 312 of mating unit 300. This design allows for fast installation and uninstallation of the mating unit 300, which is a major advantage over other security mechanisms.

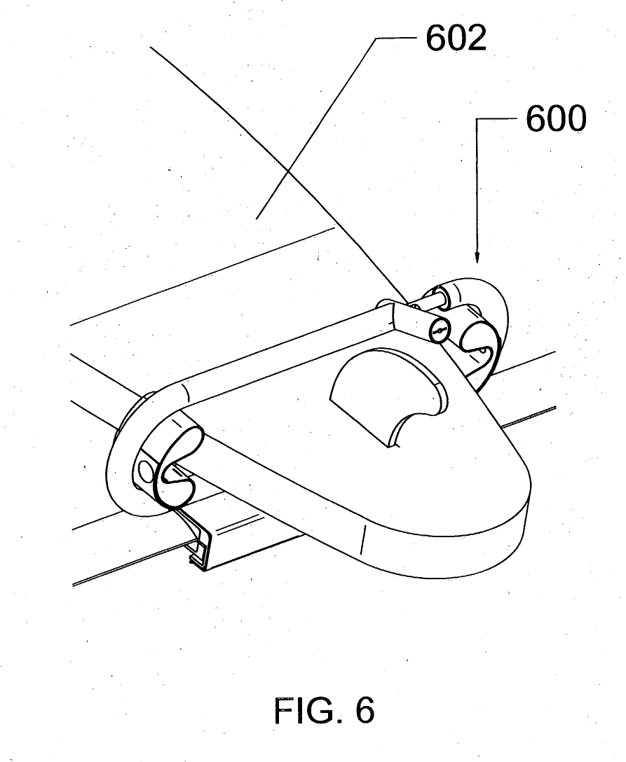

FIG. 6 illustrates another embodiment of a security apparatus 600 for securing an object to a vehicle. Shown is surfboard 602 secured to a vehicle roof rack 604. The security apparatus 600 comprises a set of mounting brackets fixedly secured to roof rack 604 and a mating unit, discussed later herein. Similar to security apparatus 100 of FIG. 1, the mating unit comprises an adjustable, locking shackle, and is designed to be easily removed from the mounting brackets when security apparatus 600 is not in use. Objects such as surfboards, skis, wakeboards, and snowboards are retained within the adjustable shackle by their respective physical properties such as board contour, fin(s), bindings, etc.

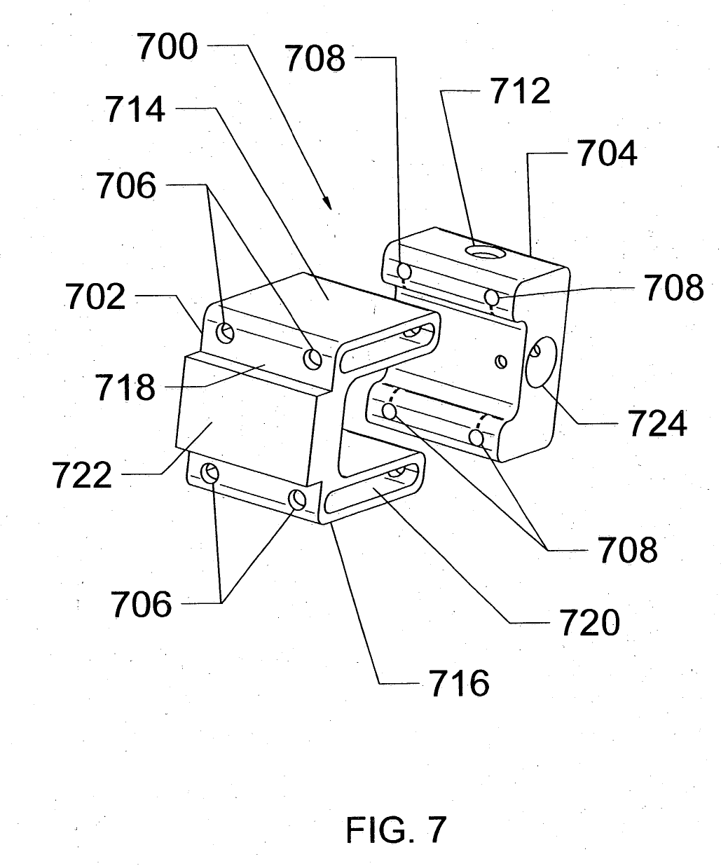

FIG. 7 illustrates a mounting bracket suitable for use with the security apparatus of FIG. 6, shown as mounting bracket 700. Mounting bracket 700 is designed to be fixedly installed onto a vehicle roof rack, and comprises U-shaped bracket 702 and receiving block 704. U-shaped bracket 702 and receiving block 704 are fixedly secured to a vehicle roof rack by placing these elements around such a rack, through an opening formed by the joinder of bracket 702 and block 704. They are secured around the roof rack using fastening means (not shown) such as screws, rivets, bolts, or any other suitable means known in the art, through holes 706 and receptacles 708. Of course, these elements may be secured by other means, such as by welding.

U-shaped bracket 702 comprises a top portion 714, a bottom portion 716, both joined by a rear portion 718. In this embodiment, top portion 714 and bottom portion 716 each comprise a channel 720 running the entire width of each portion, and rear portion 718 comprises a riser 722. These features are optional in the design of mounting bracket 700. The riser 722 is used as a; surface against which a mating unit (described below) rests upon assembly.

U-shaped bracket 702 additionally comprises four through holes 706. These holes allow mating hardware, such as screws, rivets, bolts, etc. to be inserted therethrough to engage receptacles 708, such as threaded holes or inserts, in receiving block 704.

Receiving block 704 comprises aperture 712, which is a hole that extends at least a portion through the height of receiving block 704. Aperture 712 is designed to align with two apertures located on a mating unit as the mating unit is installed onto each mounting bracket 700.

Typically, two mounting brackets 700 are used on a single roof rack for securing an object, while a second roof rack may comprise ordinary means for securing the object during transport. The two mounting brackets 700 are generally spaced apart from one another, approximately twelve inches in one embodiment. In one embodiment, receiving block 704 comprises an alignment hole 724 located on one side of receiving block 704. The alignment hole 724 is designed to receive an alignment rod (not shown) for insertion therein and to a similar hole located on a side of another mounting bracket 700. The alignment rod allows the two mounting brackets 700 to maintain a fixed relationship with each other, which may be important, depending on the shape and curvature of the roof rack to which they are secured.

It should be understood that mounting bracket 700 could comprise numerous alternative features and should not be limited to only the embodiment shown in FIG. 7. In one alternative embodiment, the bracket 702 and block 704 are formed of two sections that surround a roof rack from the bottom and the top, rather than surrounding the roof rack from the sides, as shown in FIG. 7. In other examples, fewer or a greater number of through holes 706 could be used, the through holes 706 could be threaded, aperture 712 could be located through top portion 714, bottom portion 716, and rear portion 718 either alternatively, or in addition to the aperture 712 located on receiving block 704, the alignment hole 724 could be of any cross-sectional shape, including a rectangle, triangle, ellipse, etc.

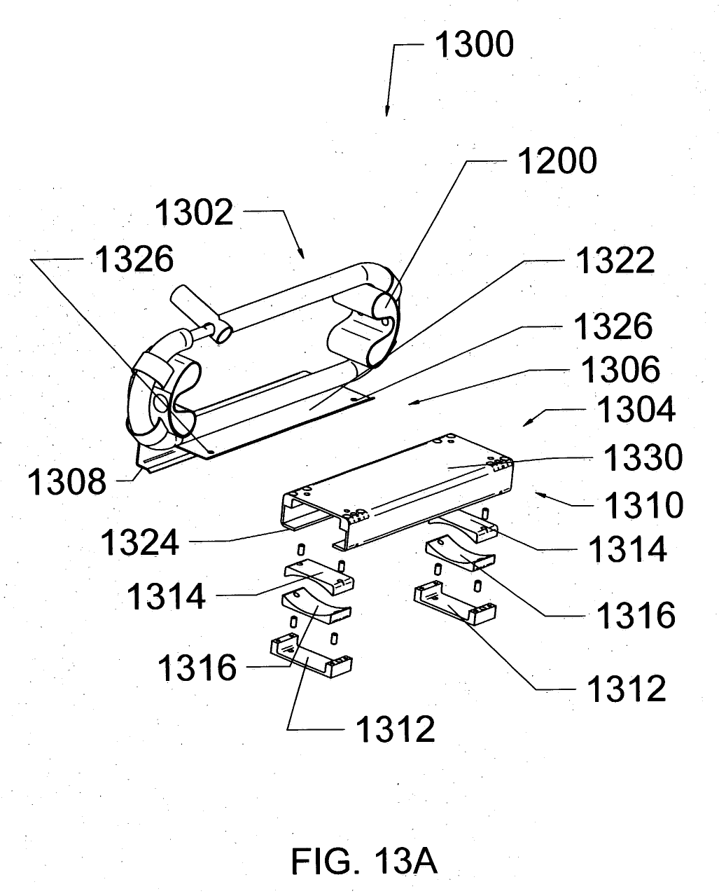

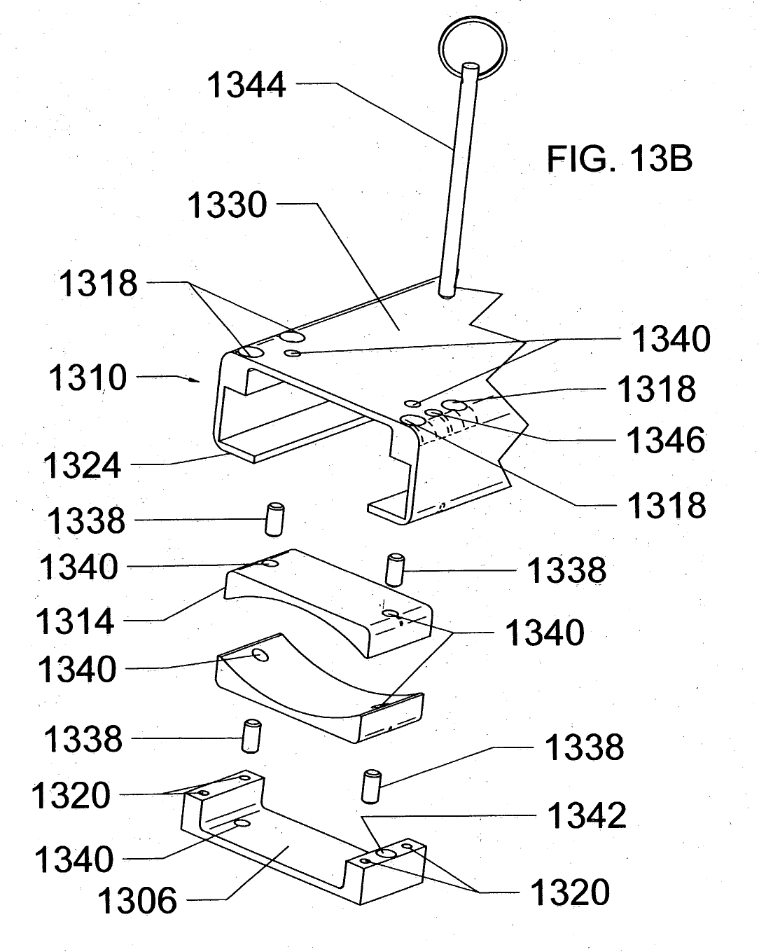

As mentioned previously, mounting bracket 700 is installed around a roof rack, typically mounted to a roof of a vehicle. However, most roof racks in use do not have a cross section conforming to the opening formed by the joinder of bracket 702 and block 704. Typically, a roof rack cross-section comprises a “wing” cross-section, being flat on a bottom surface and rounded on a top surface. In this case, mounting bracket 700 may not fit well over the roof rack, and allow the mounting bracket 700 to pitch to and fro or allow the mounting bracket 700 to slide out of position on the roof rack. To alleviate this problem, a pair of inserts may be positioned inside the opening of mounting bracket 700, having an outer surface that conforms to the surface of the mounting bracket opening, and an inner surface that conforms to the roof rack surface. Details of this type of insert can be found on FIGS. 13a and 13b, along with accompanying text.

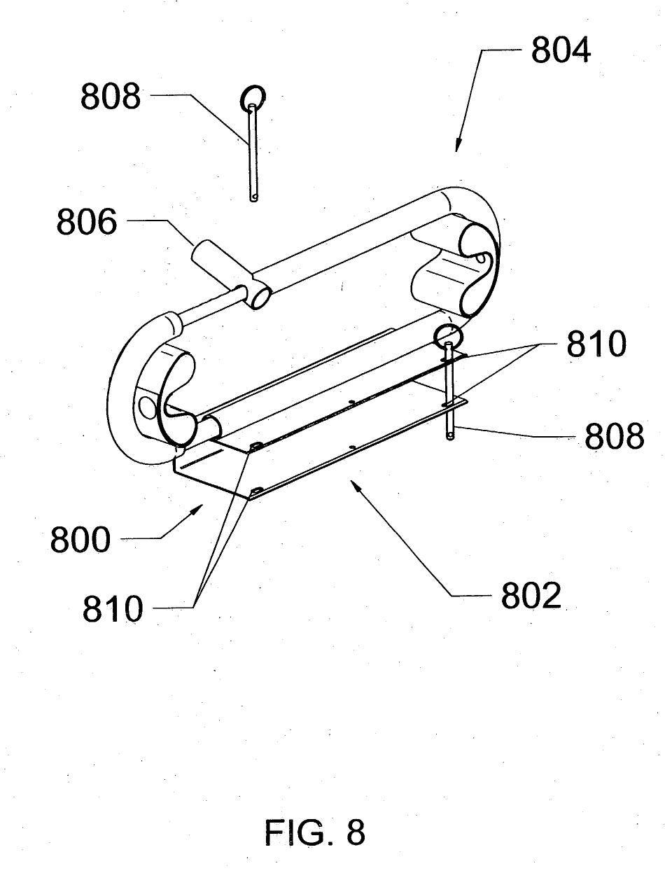

FIG. 8 illustrates a mating unit 800 suitable for use with the security apparatus of FIG. 6 and retaining pins 808. Mating unit 800 comprises a mating portion 802, an adjustable shackle 804, and a locking mechanism 806. The structures of mating unit 800 are much the same as mating unit 300, with the exception of mating portion 802. In this embodiment, mating portion 802 comprises an “U” shaped extrusion, having adjustable shackle affixed thereto. The extrusion is designed to slide over a pair of mounting brackets 700 fixedly secured to a vehicle roof rack. The extrusion is removably secured to the mounting brackets by inserting two retaining pins 808 through apertures 810 located on each end of mating portion 802 and through aperture 712 located on each of the mounting brackets. Once an object such as a surfboard is secured in place by adjustable shackle 804, the retaining pins 808 are not easily removed, because the surface of the object interferes with removal of the retaining pins 808.

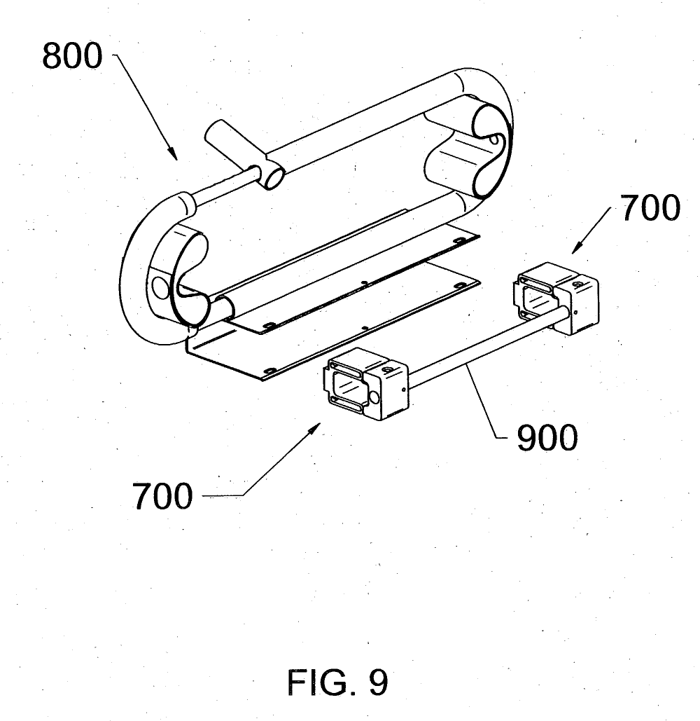

FIG. 9 illustrates the mating unit 800 of FIG. 8 about to be removably installed onto two mounting brackets 700 of FIG. 7, installed on a vehicle roof rack. Shown is optional alignment rod 900 connecting the two mating units.

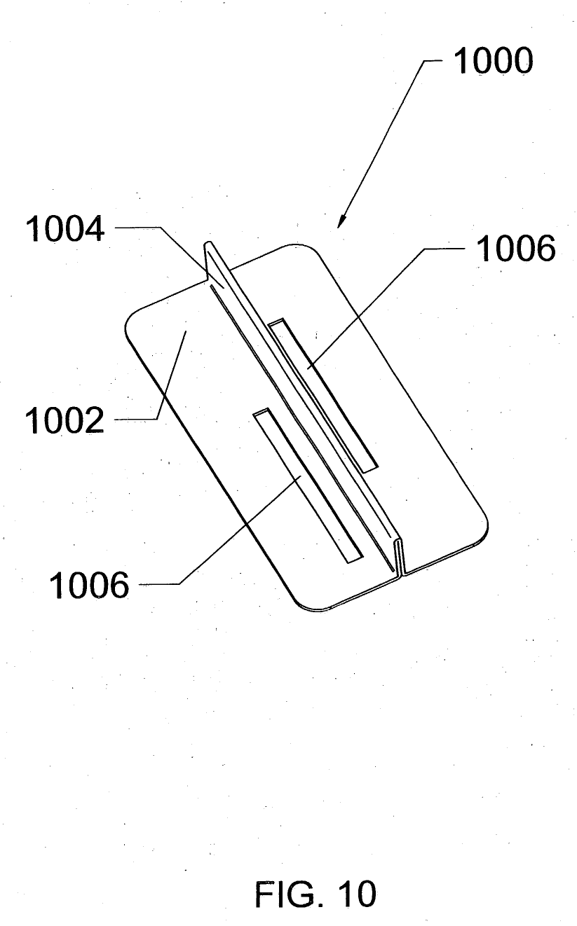

FIG. 10 illustrates an optional fin guard 1000 for use with the security apparatus of FIG. 1 or FIG. 6. Fin guard may be used in situations where the fins of a surfboard may be removed without damaging the surfboard. Removing one or more fins from a surfboard 602 secured by security apparatus 100 or 600 might allow a thief to slide the surfboard out from the adjustable shackle. Fin guard 1000 comprises a rectangular planar surface 1002, wall 1004, and one or more slots 1006. Fin guard 1000 is typically constructed of a rigid material such metal or other material difficult for a thief to destroy. Fin guard 1000 may be easily constructed from a single piece of metal and folded into a shape roughly equivalent to the structure shown in FIG. 10, or it may be formed of separate pieces and joined together using methods known in the art. Fin guard 1000 may comprise virtually any shape when viewed in a planar fashion.

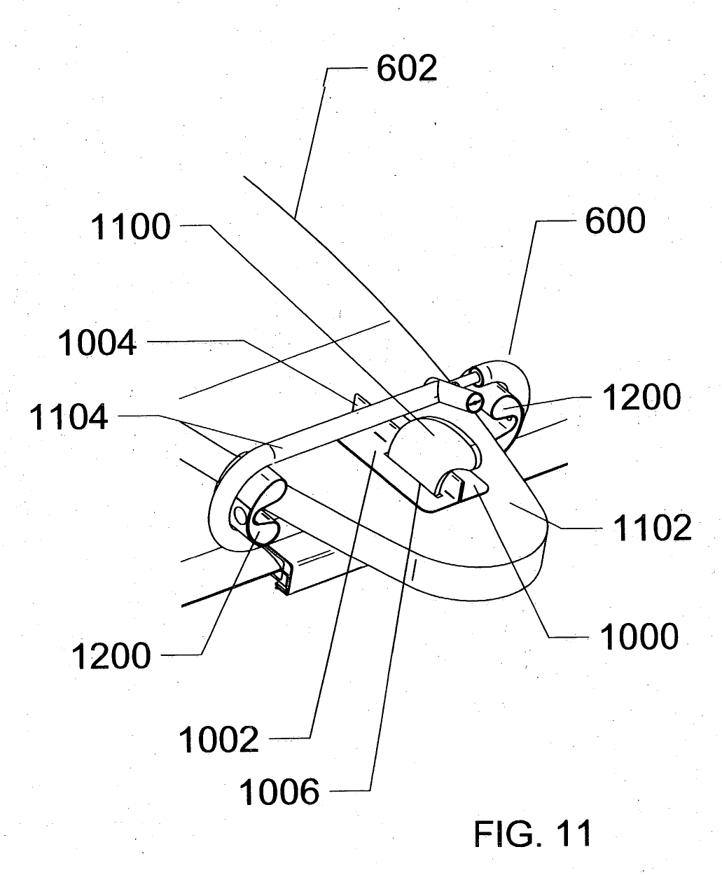

Slot 1006 is shaped to accept a surfboard fin, ideally long enough and wide enough to allow a variety of fin sizes and shapes to pass. In an alternative embodiment, fin guard 1000 may comprise two or more slots 1006, either sized differently or identical to each other, to accept various size fins and/or for placement of wall 1004 within adjustable shackle 804, as depicted in FIG. 11. Wall 1004 may comprise a length equal to, greater, or less than the length of planar surface 1002.

FIG. 11 illustrates optional fin guard 1000 in use with a surfboard 602 and security apparatus 600. Alternatively, optional fin guard 1000 can be used in a similar manner with respect to security apparatus 100. During assembly, fin 1100 is placed through slot 1006, allowing planar surface 1002 to rest against underside 1102 of surfboard 602, covering one or more mechanisms used to removably secure fin 1100 to surfboard 602. Surfboard 602 is then placed through an aperture formed by adjustable shackle 804, and the shackle is adjusted to fit snugly against the rails of surfboard 602, then locked in place. For other types of objects being secured, the shackle is adjusted to a similar physical property, such as the edges of a wakeboard, snowboard, or the like. At this point, the surfboard 602 is prevented from being moved fore or aft, due to fin 1100 and the increased width of surfboard 602, respectively. Accordingly, fin guard 1000 remains in a fixed or near-fixed relationship with adjustable shackle 304. Specifically, the wall 1004 remains wedged underneath a top portion 1104 of either fixed portion 314 or adjustable portion 316. It should be understood that the top portion of wall 1004 need not make contact with top portion 1104, or any other portion of adjustable shackle 804, as long as planar surface 1002 is not able to be moved a distance that would allow access to the one or more mechanisms removably securing fin 1100 to surfboard 602. Wall 1004 is sufficient in length to extend far enough past adjustable shackle 804 so that fin guard 1000 can not be removed or moved enough to compromise the one or more mechanisms, even if surfboard 602 is forced fore or aft to its physical limitations imposed by adjustable shackle 804.

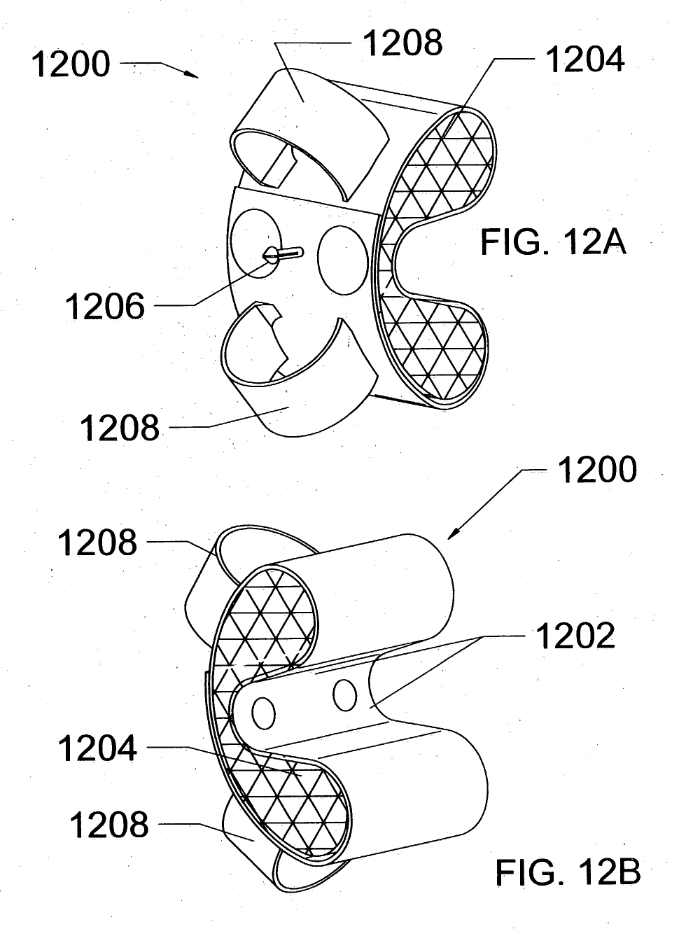

FIGS. 12a and 12b illustrate two views of an optional cushion 1200 used in the security apparatus of FIG. 1 or FIG. 6. Cushion 1200 is typically used in pairs, each cushion secured to a curved portion of adjustable shackle 304 or 804, as the case may be. Although not essential to the embodiments described herein, the optional cushions allow a surfboard 102 to be secured within an opening formed by adjustable shackle 304 or 804 without damaging the rails of surfboard 102. Additionally, the cushions 1200 allow a top and bottom surfaces of surfboard 102 to avoid contact with an inside surface of adjustable shackle 304 or 804, thereby avoiding damage to those surfaces.

Cushion 1200 comprises a contact surface 1202 which is designed to conform to a surfboard rail cross-section. Contact surface 1202 comprises a material which is semi-rigid, allowing the contact surface 1202 to flex and fit snugly against a surfboard rail. The material comprises a smooth surface so that the surfboard rails are not scratched or otherwise damaged by the cushion. Examples of such materials include plastic, rubber, polyurethane, or other suitable material. Cushion 1200 typically comprises filler 1204 for helping maintain the overall shape of the cushion. Filler 1204 may comprise varying degrees of elasticity, ranging from soft to hard. In one embodiment, filler 1204 comprises foam rubber, but in other embodiments, could comprise plastic, epoxy, resin, rubber, wood, etc. In yet another embodiment, no filler is used.

It should also be understood that cushion 200 could alternatively comprise a malleable object, such as a balloon filled with gel, air, or some other material. In such an embodiment, cushion 200 would conform to a surfboard rail cross-section upon impact with the surfboard.

Cushion 1200 typically comprises one or more means for securing the cushion to adjustable shackle 304 or 804. As illustrated in FIG. 12, fastening means 1206 comprises a pin which comprises a flared end that is inserted through a hole located on a curved portion inner surface of adjustable shackle 304 or 804. The length of the pin is such that it will not allow cushion 1200 to be rotated or displaced laterally, disengaging the pin from the hole in the curved portion, thereby providing additional clearance that could allow the surfboard to be removed. Cushion 1200 additionally comprises retainers 1208 for wrapping around a portion of adjustable shackle 304 or 804, thereby additionally securing cushion 1200 in place. The retainers 1208 may comprise any material for wrapping around a portion of adjustable shackle 304 or 804 including string, tie-wraps, leather straps, or, in the embodiment shown in FIG. 12, Velcro straps. The retainers 1208 are secured to a rear portion of cushion 1200 by any suitable means, such as a pin, rivet, or other means.

FIGS. 13a and 13b are exploded views of yet another embodiment of a security apparatus 1300 for securing an object to a vehicle. Cushions 1200 are installed as illustrated. The security apparatus of this embodiment comprises mating unit 1302 and mounting bracket 1304. The mating unit 1302 is quite similar to mating unit 300 of FIG. 3 with the exception of mating portion 1306. Mating portion 1306 comprises an L-shaped extrusion which slides over mounting bracket 1304 upon installation. Mating portion 1306 comprises a bottom lip 1308 which prevents mating unit 1302 from being removed from mounting bracket 1304 after mating unit 1302 is removably secured to mounting bracket 1304.

Mounting bracket 1304 comprises extrusion 1310, lower bracket 1312, upper insert 1314, and lower insert 1316. A vehicle roof rack is sandwiched between upper insert 1314 and lower insert 1316, then the inserts are secured within extrusion 1310 using lower bracket 1312.

FIG. 13b shows a more detailed view of extrusion 1310, lower bracket 1312, upper insert 1314, and lower insert 1316. Lower insert 1316 is held within lower bracket 1312 and upper insert 1314 held within extrusion 1310 by one or more fastening means 1338. Fastening means 1338 comprises four retaining pins which fit into receiving holes 1340 located on extrusion 1310, lower bracket 1312, upper insert 1314, and lower insert 1316, as shown. Of course, a greater or fewer number of fastening means could be used in the alternative, or other means could be used, either alternatively or in addition to, to fasten the inserts to extrusion 1310 and lower bracket 1312. When the components of FIG. 13b are assembled, the inserts form an opening which conforms to the shape of a vehicle roof rack. The inner surface of the inserts may be shaped to conform with the different roof rack shapes available on the market from vehicle manufacturers or after-market suppliers.

The lower bracket 1312 is fixedly secured to extrusion 1310 using any known fastening means, such as screws, rivets, bolts, etc. through holes 1318 and 1320. Four pairs of such holes are shown in the embodiment of FIG. 13b but a fewer or greater number of holes could be used in the alternative. The lower bracket 1312 may be secured to extrusion 1310 by other means, such as welding, either in addition or alternatively to the screws, rivets, or bolts. The mounting bracket 1304, therefore, is generally fixedly secured to a vehicle roof rack, and remains in place whether or not mating unit 1302 is attached. The inserts are held securely in place by the clamping force of the securing means.

Lower bracket 1312 comprises apertures 1342 which align with apertures 1346 on extrusion 1310 when assembly is complete. These apertures allow a retaining pin 1344 to be inserted therethrough. The apertures 1342 may comprise through holes or they may only extend a portion through lower bracket 1312.

During assembly of mating unit 1302 to mounting bracket 1304, the mating unit 1302 slides onto mounting bracket 1304, with an upper surface 1322 covering an upper surface 1330 of extrusion 1310. Bottom lip 1308 covers a portion of a lower surface 1324 of extrusion 1310. One or more apertures 1326 located on upper surface 1322 align with one or more apertures 1346 located on upper surface 1330 of extrusion 1310. A retaining pin 1344 similar to retaining pin 322 is then inserted through apertures 1326, 1346, and 1342, thereby removably securing mating unit 1302 to mounting bracket 1304. Like previous embodiments, the retaining pin is not removable when an object is secured through the adjustable shackle.

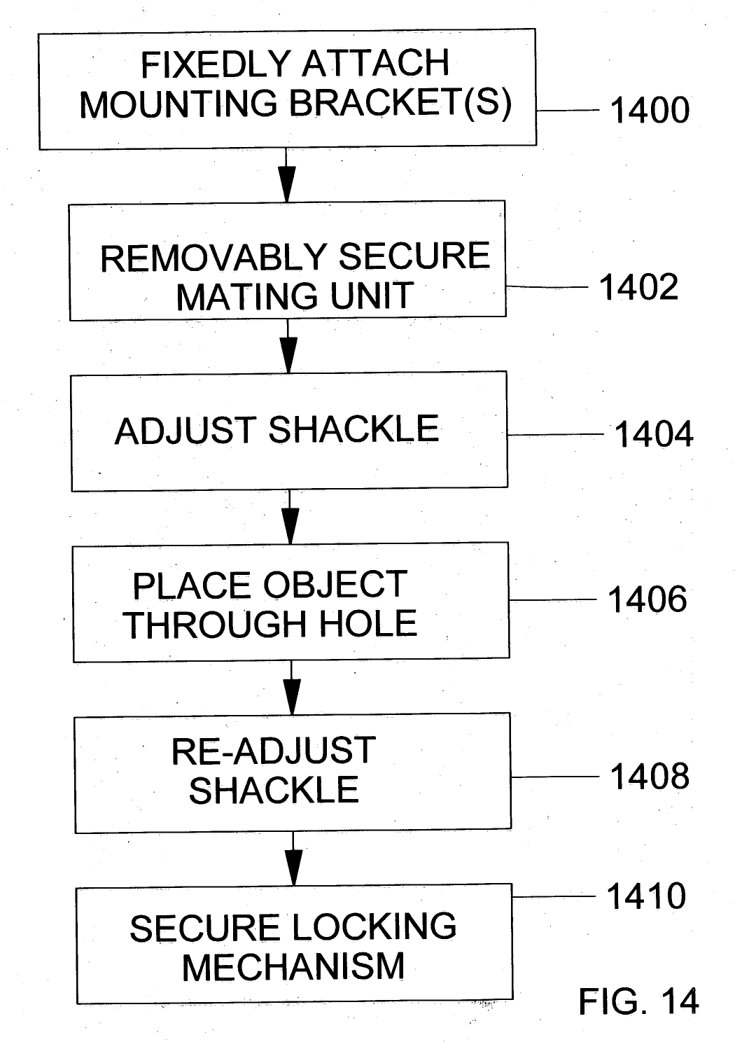

FIG. 14 is a flow diagram illustrating a method for securing an object, such as a surfboard, to a vehicle. The method conforms to the embodiments illustrated in FIG. 1 and FIG. 6, and will be referenced accordingly.

In step 1400, mounting bracket 200 (700) is fixedly attached to a surface of a vehicle, for example, to an inside surface of a pickup truck tailgate or to an existing vehicle roof rack. Mounting bracket 200 (700) is preferably attached in a manner which prevents quick removal of the mounting bracket. Mounting bracket 200 (700) is designed to remain fixedly attached to the vehicle, whether an object is being secured or not.

In step 1402, mating unit 300 (800) is removably secured to mounting bracket 200 (700). In one embodiment, tabs 312 of mating portion 302 are inserted through slots 212 located on bottom surface 210 of mounting bracket 200. Mating unit 300 is then tilted towards mounting bracket 200 until top surface 308 of mating unit 300 overlaps top surface 206 of mounting bracket 200. At this point, aperture 310 of mating unit 300 will align with aperture 208 of mounting bracket 200. Mating unit 300 is then removably secured to mounting bracket 200 by inserting a retaining pin 322 through the two apertures. Advantageously, this design prevents removal of retaining pin 322 when an object such as a surfboard is secured through an opening formed by adjustable aperture 304.

In another embodiment, mating unit 800 comprises a U-shaped mating portion 802 which encloses mounting brackets 700. The mating unit comprises one or more apertures 810, each which align with a corresponding aperture 712 located on receiving block 704. A retaining pin 808 is inserted through each pair of apertures, removably securing mating unit 800 to mounting bracket 700.

In step 1404, adjustable portion 316 of adjustable shackle 304 (or adjustable portion of adjustable shackle 804) is moved if necessary to accommodate the object being secured. Locking mechanism 306 (806) is generally placed in an unlocked position to allow movement of adjustable portion 316 (or adjustable portion of adjustable shackle 804) during this step.

In step 1406, the object to be secured is placed through an opening formed by adjustable shackle 304 (804). In the case of a surfboard, the surfboard is generally placed upside down with the fin(s) extending upward. The nose of the surfboard is then placed through the opening of adjustable shackle 304 (804), resting on a floor of a pickup truck bed in one embodiment, or a front portion of the surfboard resting on a standard securing system or second security apparatus 600 located on a forward roof rack in another embodiment. The surfboard is positioned forward until either the fin(s) touch adjustable shackle 304 (804), or the width of the surfboard begins to narrow. Alternatively, adjustable portion 316 (or adjustable portion of adjustable shackle 804) may be completely removed from fixed portion 314, thereby allowing the surfboard to be slid sideways into the opening formed by fixed portion 314.

In step 1408, adjustable portion 316 is moved relative to fixed portion 314, such that the opening formed by adjustable shackle 304 is reduced in size to fit snugly against opposing rails of the surfboard. In one embodiment, locking mechanism 306 may be in a locked or an unlock position during this step (i.e., the locking mechanism 306 in combination with notches 318 forming a one-way ratchet). Similar operations apply to security apparatus 600.

In step 1410, locking mechanism 306 (806) is placed into a locked position, generally by using a key. The surfboard is now securely fastened to the security apparatus 100 (600). Retaining pin 322 (or pins 808) is inaccessible until the surfboard 102 is removed from adjustable shackle 304 (804).

Removal of surfboard 102 is a process reversed from the just-described process of FIG. 13. Mating unit 300 (800) may then be placed within the confines of the vehicle and stored until needed once more.

The previous description of the preferred embodiments is provided to enable any person skilled in the art to make and use the present invention. The various modifications to these embodiments will be readily apparent to those skilled in the art, and the generic principles defined herein may be applied to other embodiments without the use of the inventive faculty. Thus, the present invention is not intended to be limited to the embodiments discussed herein, but is to be accorded the widest scope consistent with the principles and novel features disclosed herein.

1. An apparatus for securing an object to a vehicle, comprising:
a mounting bracket;
a mating unit removably connected to the mounting bracket, the mating unit comprising:
an adjustable shackle;
a mating portion, the mating portion being fixedly secured to said adjustable shackle; and
a locking mechanism, the locking mechanism operative to allow adjustment of said shackle in an unlocked position and to prevent adjustment of said shackle in a locked position; and
means for removably securing the mating portion to the mounting bracket.

2. The apparatus of claim 1, wherein the means for removably securing the mating portion to the mounting bracket is inaccessible after the object is secured by the adjustable shackle.

3. The apparatus of claim 1 wherein the means for securing comprise a retaining pin, a first aperture located on the mounting bracket, and a second aperture located on the mating unit, wherein the first aperture and the second aperture are aligned with each other and the retaining pin is inserted into the first and second apertures, thereby maintaining the mounting bracket and the mating unit in a fixed relationship with each other.

4. The apparatus of claim 3 wherein the mounting bracket further comprises a slotted lower surface and the mating unit further comprises a tabbed lower surface, the tabbed lower surface for insertion into the slotted lower surface.

5. The apparatus of claim 3, wherein the retaining pin is inaccessible when the object is secured through an opening formed by the adjustable shackle.

6. The apparatus of claim 1, further comprising a fin guard for covering a fin removal mechanism on the object and for preventing access to the fin removal mechanism.

7. The apparatus of claim 1, wherein the mounting bracket comprises a rear planar surface for mounting to the vehicle, an upper portion connected to the rear planar surface, and a lower portion connected to the rear planar surface, the upper portion and the lower portion for receiving the mating unit.

8. The apparatus of claim 1, wherein the mounting bracket comprises:
a U-shaped bracket;
a receiving block, and
means for fixedly securing the U-shaped bracket around a vehicle roof rack.

9. The apparatus of claim 1 further comprising:
a cushion, the cushion comprising a surface substantially conforming to a cross-section of an edge of the object, the cushion secured to the adjustable shackle.

10. The apparatus of claim 1 wherein the mounting bracket comprises:
a lower bracket comprising a first aperture for receiving a retaining pin;
a lower insert for mounting within the lower bracket and comprising a second aperture for receiving the retaining pin;
an upper insert for mounting within an extrusion and comprising a third aperture for receiving the retaining pin;
the extrusion comprising a fourth aperture for receiving the retaining pin; and
means for fixedly securing the extrusion, the lower bracket, the lower insert, and the upper insert around a vehicle roof rack.

11. The apparatus of claim 1 wherein the object comprises a surfboard.

12. The apparatus of claim 1 wherein the object comprises a snowboard.

13. A method for securing an object to a vehicle, comprising:
installing a mounting bracket fixedly to the vehicle;
removably attaching a mating unit to the mounting bracket, the mating unit comprising an adjustable shackle operative to secure said object to said mating unit;
placing said object through an opening formed by said shackle;
adjusting said shackle to fit snugly against opposing edges of said object; and
locking said shackle.

14. The method of claim 13 further comprising installing a fin guard over a removable fin on the surfboard, the fin guard for preventing access to a fin removal mechanism.

15. The method of claim 13, wherein the object comprises a surfboard.

16. The method of claim 13, wherein the object comprises a snowboard.
